(19) United States
(12) Patent Application Publication
(10) Pub. No.: US 2023/0329314 A1
(43) Pub. Date: Oct. 19, 2023

(54) GAS COMPOSITIONS FOR MODIFICATION OF FOOD AND BEVERAGE PRODUCTS

(71) Applicant: Rubix Foods, LLC, Jacksonville, FL (US)

(72) Inventors: Luis Martinez, Jacksonville, FL (US); Stephen Koltun, Jacksonville, FL (US); Yvette Pascua Cubides, Jacksonville, FL (US); Stephen Sotomayor, Jacksonville, FL (US)

(21) Appl. No.: 18/300,139

(22) Filed: Apr. 13, 2023

Related U.S. Application Data
(60) Provisional application No. 63/330,623, filed on Apr. 13, 2022.

(51) Int. Cl. A23P 30/40; A23F 5/46; A23C 11/00; A23C 9/00; B01F 23/235; B01F 23/237; B65D 83/14

(52) U.S. Cl. CPC A23P 30/40; A23F 5/465; A23C 11/00; A23C 9/00; B01F 23/235; B01F 23/23765; B01F 23/237621; B01F 23/23762; B01F 23/237611; B65D 83/14; B01F 2101/07

(57) ABSTRACT

Disclosed herein are compositions and methods for modification of a food product such as a foam topping that can be used to modify a beverage or food product. In particular, described herein are methods for modifying a beverage or food product by applying to and draining, dissolving, and/or dispersing a portion of a foam food product in the beverage or food product. In addition, methods for modifying the texture of a foam food product are disclosed herein. Also described are compositions comprising gas mixtures for modifying the texture of a foam food product and a beverage or food product.

### CROSS-REFERENCE TO RELATED APPLICATIONS

This application claims priority to U.S. Provisional Patent Application No. 63/330,623, filed on Apr. 13, 2022, which is incorporated by reference herein in its entirety.

### FIELD

This disclosure relates to methods and compositions for modification of food and beverage products. Described herein are methods for modifying a food or beverage product by applying to and dissolving, dispersing, and/or draining a portion of a foam food product in the food or beverage product. In addition, methods for modifying the texture of a foam food product are described herein. Also described are compositions comprising gas mixtures for modifying the texture of a foam food product, a food product, and a beverage.

### INTRODUCTION

Aerated food products such as foam food products are widely known. For example, food products like mousses and whipped creams are food foams that contain air bubbles that are stabilized in the food product. Such food foams are commonly used as accompaniments and/or toppings for food products such as desserts and beverages. Gases typically used for aeration include air, nitrogen, nitrous oxide, and carbon dioxide. Two factors of importance in the development of aerated food products include foamability and foam stability. Foamability refers to the degree to which a gas phase can be dispersed in the product, leading to an increase in volume. Foam stability, on the other hand, refers to the foam's resistance to bubble, coalesce, and subsequent collapse causing a reduced volume as well as its resistance to drainage of the continuous phase from between the bubbles. Consumer selection of foam products depends on the consumer's sensory expectations of texture, taste, and various stability indicators. Consumer selection of foam products also depends on the intended use of the foam product and its effect on a food product or beverage to which it is applied.

There is a demand in the market for foam products that add texture and taste to food products and beverages such as those found in specialty coffees from coffeehouses or at home use offerings. In addition, social media trends have also created a demand for beverage variations that help consumers experience traditional products in a different and/or renovated manner and are photography friendly. Currently, consumers are limited to foam toppings that accompany a beverage or food product by only floating on top of the beverage or resting beside the food product. These foam toppings have little to no interaction with the beverage or food product when applied, requiring the consumer to manually stir the foam into the beverage or food product after application. Conversely, consumers can choose to rapidly cream their beverage with the use of a nitrogen pressurized creamer. However, these nitrogen creamers do not produce a foam topping. Thus, the ability to enhance the organoleptic properties of a beverage or food product as well as the sensory experience for a consumer of the beverage or food product through flavor and/or texture modification is currently limited to either manual manipulation of a foam topping or use of nitrogen propelled creamer.

Thus, there is a need for a novel approach to enhance the organoleptic properties of a beverage or food product as well as a consumer's sensory experience through the use of a foamable food product that can be used simultaneously as a topping, a creamer, and/or a flavor/texture modifier.

### SUMMARY

In one aspect, the disclosure relates to a method of modifying a beverage or food product, comprising: in a container, mixing two or more gases and a liquid food product thereby dissolving a portion of the gas mixture into the liquid food product and forming a foamable food product; applying the foamable food product to the beverage or food product by expelling the foamable food product from the container, wherein the foamable food product expands to form a foam food product wherein a first portion of the foam food product remains on the surface of the beverage or food product and a second portion of the foam food product dissolves, disperses, and/or drains into the beverage or food product. In an embodiment, the amount of the first portion of the foam food product and the amount of the second portion of the foam food product depends on the composition of the gas mixture, the pressure inside the container, or a combination thereof. In another embodiment, the second portion of the foam food product adds flavor to the beverage or food product, modifies the texture of the beverage or food product, modifies the color of the beverage or food product, or a combination thereof. In another embodiment, the beverage or food product is one or more of a coffee, a tea, a juice, a milk, a smoothie, a milkshake, a soft drink, water, a flavored water, an alcoholic beverage, a mocktail, a soup, a broth, cocoa, cake, meat, crepes.

In a further aspect, the disclosure relates to a method of modifying the texture of a foam food product, comprising: in a container, mixing a gas mixture comprising two or more gases with a liquid food product thereby dissolving a first portion of the gas mixture into the liquid food product and forming a foamable food product; expelling the foamable food product from the container, wherein the foamable food product expands to form the foam food product. In an embodiment, the mixing of two or more gases and a liquid food product comprises filling a first portion of a container with a liquid food product and filling a second portion of the container with the gas mixture, thereby pressurizing the container. In another embodiment, a second portion of the gas mixture occupies space in the container unoccupied by the foamable food product thereby acting as a propellent. In another embodiment, the container is a pressure-resistant container with either single or dual internal chamber comprising a base, a sidewall, and a valve. In another embodiment, expelling the foamable food product from the container comprises activating the valve of the container and expelling the foamable food product from the container through a nozzle. In another embodiment, at least a portion of the second portion of the gas mixture is dissolved into the foamable food product by shaking the container to expel the foamable food product from the container. In another embodiment, the two or more gases are selected from the group consisting of nitrous oxide (N₂O), nitrogen (N₂), carbon dioxide (CO₂), argon (Ar), helium (He), and compressed air. In another embodiment, when the gas mixture comprises two gases, a first gas is from about 5% to about 95% and a second gas is from about 5% to about 95% of the gas mixture. In another embodiment, when the gas mixture comprises three gases, a first gas is from about 5% to about 90%, a second gas is from about 5% to about 90%, and a third gas is from about 5% to about 90% of the gas mixture. In another embodiment, when the gas mixture comprises four gases, a first gas is from about 5% to about 85%, a second gas is from about 5% to about 85%, a third gas is from about 5% to about 85%, and a fourth gas is from about 5% to about 85% of the gas mixture. In another embodiment, the gas mixture comprises a blend of: N₂O and N₂; N₂O and CO₂; N₂O and Ar; N₂O and He; N₂O and compressed air; N₂ and CO₂; N₂ and Ar; N₂ and He; N₂ and compressed air; CO₂ and Ar; CO₂ and He; CO₂ and compressed air; Ar and He; Ar and compressed air; or, He and compressed air. In another embodiment, the gas mixture comprises a blend of: N₂O, N₂, and CO₂; N₂O, N₂, and Ar; N₂O, N₂, and He; N₂O, N₂, and compressed air; N₂O, CO₂, and Ar; N₂O, CO₂, and He; N₂O, CO₂, and compressed air; N₂O, Ar, and He; N₂O, Ar, and compressed air; N₂O, He, and compressed air; N₂, CO₂, and Ar; N₂, CO₂, and He; N₂, CO₂, and compressed air; N₂, Ar, and He; N₂, Ar, and compressed air; N₂, He, and compressed air; CO₂, Ar, and He; CO₂, Ar, and compressed air; CO₂, He, and compressed air; or, Ar, He, and compressed air. In another embodiment, the gas mixture comprises a blend of: N₂O, N₂, CO₂, and Ar; N₂O, N₂, CO₂, and He; N₂O, N₂, CO₂, and compressed air; N₂O, CO₂, Ar, and He; N₂O, CO₂, Ar, and compressed air; N₂O, Ar, He, and compressed air; N₂, CO₂, Ar, and He; N₂, CO₂, Ar, and compressed air; N₂, Ar, He, and compressed air; or, CO₂, Ar, He, and compressed air. In another embodiment, from about 0.002% to about 50% of the gas mixture is dissolved into the liquid food product. In another embodiment, the first portion of the container is from about 30% to about 90% of the container. In another embodiment, the second portion of the container is from about 10% to about 70% of the container. In another embodiment, the container is pressurized to a total pressure of from about 0 psi to about the bursting pressure of the container. In another embodiment, the foam food product has one or more of the following characteristics: an overrun of from about 10% to about 600%; a bubble size of from about 3 μnm to about 1 in; 0 min to 5 min for bubbles to coalesce; 0 min to 10 min for a 50% reduction in foam volume; a drainage rate of from about 0 g/sec to about 100 g/sec; 0 cm to 5 cm foam height; a specific gravity of from about 0.1 g/cm³ to about 0.5 g/cm³; and, 0% to 100% solubility in a beverage.

Another aspect of the disclosure provides a gas mixture for improving the texture of a foam food product, a beverage, or a combination thereof, comprising at least two gases selected from the group consisting of nitrous oxide (N₂O), nitrogen (N₂), carbon dioxide (CO₂), argon (Ar), helium (He), and compressed air. In an embodiment, when the gas mixture comprises two gases, a first gas is from about 5% to about 95% and a second gas is from about 5% to about 95% of the gas mixture. In another embodiment, when the gas mixture comprises three gases, a first gas is from about 5% to about 90%, a second gas is from about 5% to about 90%, and a third gas is from about 5% to about 90% of the gas mixture. In another embodiment, when the gas mixture comprises four gases, a first gas is from about 5% to about 85%, a second gas is from about 5% to about 85%, a third gas is from about 5% to about 85%, and a fourth gas is from about 5% to about 85% of the gas mixture. In another embodiment, the gas mixture comprises a blend of: N₂O and N₂; N₂O and CO₂; N₂O and Ar; N₂O and He; N₂O and compressed air; N₂ and CO₂; N₂ and Ar; N₂ and He; N₂ and compressed air; CO₂ and Ar; CO₂ and He; CO₂ and compressed air; Ar and He; Ar and compressed air; or, He and compressed air. In another embodiment, the gas mixture comprises a blend of: N₂O, N₂, and CO₂; N₂O, N₂, and Ar; N₂O, N₂, and He; N₂O, N₂, and compressed air; N₂O, CO₂, and Ar; N₂O, CO₂, and He; N₂O, CO₂, and compressed air; N₂O, Ar, and He; N₂O, Ar, and compressed air; N₂O, He, and compressed air; N₂, CO₂, and Ar; N₂, CO₂, and He; N₂, CO₂, and compressed air; N₂, Ar, and He; N₂, Ar, and compressed air; N₂, He, and compressed air; CO₂, Ar, and He; CO₂, Ar, and compressed air; CO₂, He, and compressed air; or, Ar, He, and compressed air. In another embodiment, the gas mixture comprises a blend of: N₂O, N₂, CO₂, and Ar; N₂O, N₂, CO₂, and He; N₂O, N₂, CO₂, and compressed air; N₂O, CO₂, Ar, and He; N₂O, CO₂, Ar, and compressed air; N₂O, Ar, He, and compressed air; N₂, CO₂, Ar, and He; N₂, CO₂, Ar, and compressed air; N₂, Ar, He, and compressed air; or, CO₂, Ar, He, and compressed air.

Another aspect of the disclosure provides a pressurized container comprising: a gas mixture comprising two or more gases selected from the group consisting of nitrous oxide (N₂O), nitrogen (N₂), carbon dioxide (CO₂), argon (Ar), helium (He), and compressed air; and a liquid food product. In an embodiment, when the gas mixture comprises two gases, a first gas is from about 5% to about 95% and a second gas is from about 5% to about 95% of the gas mixture. In another embodiment, when the gas mixture comprises three gases, a first gas is from about 5% to about 90%, a second gas is from about 5% to about 90%, and a third gas is from about 5% to about 90% of the gas mixture. In another embodiment, when the gas mixture comprises four gases, a first gas is from about 5% to about 85%, a second gas is from about 5% to about 85%, a third gas is from about 5% to about 85%, and a fourth gas is from about 5% to about 85% of the gas mixture. In another embodiment, the gas mixture comprises a blend of: N₂O and N₂; N₂O and CO₂; N₂O and Ar; N₂O and He; N₂O and compressed air; N₂ and CO₂; N₂ and Ar; N₂ and He; N₂ and compressed air; CO₂ and Ar; CO₂ and He; CO₂ and compressed air; Ar and He; Ar and compressed air; or, He and compressed air. In another embodiment, the gas mixture comprises a blend of: N₂O, N₂, and CO₂; N₂O, N₂, and Ar; N₂O, N₂, and He; N₂O, N₂, and compressed air; N₂O, CO₂, and Ar; N₂O, CO₂, and He; N₂O, CO₂, and compressed air; N₂O, Ar, and He; N₂O, Ar, and compressed air; N₂O, He, and compressed air; N₂, CO₂, and Ar; N₂, CO₂, and He; N₂, CO₂, and compressed air; N₂, Ar, and He; N₂, Ar, and compressed air; N₂, He, and compressed air; CO₂, Ar, and He; CO₂, Ar, and compressed air; CO₂, He, and compressed air; or, Ar, He, and compressed air. In another embodiment, the gas mixture comprises a blend of: N₂O, N₂, CO₂, and Ar; N₂O, N₂, CO₂, and He; H₂O, N₂, CO₂, and compressed air; N₂O, CO₂, Ar, and He; N₂O, CO₂, Ar, and compressed air; N₂O, Ar, He, and compressed air; N₂, CO₂, Ar, and He; N₂, CO₂, Ar, and compressed air; N₂, Ar, He, and compressed air; or, CO₂, Ar, He, and compressed air. In another embodiment, the container is a single chamber pressure-resistant container or a dual chamber pressure-resistant container comprising a base, a sidewall, and a valve. In another embodiment, the container is pressurized to a total pressure of from about 0 psi to about the bursting pressure of the container.

This disclosure provides for other aspects and embodiments that will be apparent in light of the following detailed description and accompanying drawings.

### BRIEF DESCRIPTION OF THE DRAWINGS

FIG. 1 is a graph showing the effect of different N₂:N₂O gas ratios on the ratio of non-dairy creamer foam to fluid cold brew coffee beverage (i.e., foam to beverage ratio) after 1, 5, and 10 minutes.

FIG. 2 is a graph showing the effect of different N₂:N₂O gas ratios on the volume of liquid drained from the gas treatment foams into the liquid portion of the beverage after 1, 5, and minutes.

FIG. 3 is a graph showing the effect of different N₂:N₂O gas ratios on the change in floating foam volume over beverage from the gas treatment foams after 1, 5, and 10 minutes.

Before any embodiments of the disclosure are explained in detail, it is to be understood that the disclosure is not limited in its application to the details of construction and the arrangement of components set forth in the following description or illustrated in the following drawings. Also, it is to be understood that the phraseology and terminology used herein is for the purpose of description and should not be regarded as limiting.

### DETAILED DESCRIPTION

Described herein are methods of modifying a beverage and/or food product with a foam food product and methods of modifying the texture of said foam food product. Also disclosed herein are gas mixture compositions comprising at least two gases selected from the group consisting of nitrous oxide (N₂O), nitrogen (N₂), carbon dioxide (CO₂), argon (Ar), helium (He), and compressed air used to enable modification of a foam food product intended for customized sensory enhancement of a beverage and/or food product.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9; for the range from 6 to 9, the numbers 7 and 8 are contemplated in addition to 6 and 9; and for the range 6.0-7.0, the number 6.0, 6.1, 6.2, 6.3, 6.4, 6.5, 6.6, 6.7, 6.8, 6.9, and 7.0 are explicitly contemplated.

The term “about” or “approximately” as used herein as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In certain aspects, the term “about” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Alternatively, “about” can mean within 3 or more than 3 standard deviations, per the practice in the art. Alternatively, such as with respect to biological systems or processes, the term “about” can mean within an order of magnitude, preferably within 5-fold, and more preferably within 2-fold, of a value.

The term “air” as used herein refers to a mixture of gases that makes up the Earth's atmosphere. Air may primarily comprise nitrogen (78%), mixed with oxygen (21%), water vapor (variable), argon (0.93%), carbon dioxide (0.04%), and trace gases.

“Bursting pressure” as used herein refers to the amount of pressure (e.g., psi) that a container, such as a can, is able to hold without exceeding the tensile strength of the container.

“Compressed air” as used herein refers to air under pressure greater than that of the atmosphere (greater than about 14.6959 psi).

“Foamable” or “whippable” refer to a food product or composition that is capable of entrapping a dispersed gas phase and undergoing volume expansion when expelled into atmospheric pressure from a pressurized container.

“Foam,” “foamed,” “whipped” food product, and similar terms refer to a product that is comprised of a dispersed gas phase that forms bubbles, entrapped within a continuous fluid, semi-solid or solid phase. Furthermore, a foam refers to a foamable food product that has expanded in volume after being released from a pressurized container.

The term “modifying” as used herein refers to transforming a structure, flavor, or texture of a foam product or applied beverage or food product from its original form. “Modifying” also includes improving the stability of a structure as compared to its original stability prior to any treatment or modification. In an embodiment, a gas mixture as described herein may alter the pressure and/or solubility of a foam food product as described herein such that when applied to a beverage can cause it to become fizzy (i.e., rapid release of gas bubbles). In another embodiment, a gas mixture as described herein may increase the stability of a foam food product such that a stiffer foam is produced when applied to a beverage (e.g., peaks in foam, has structure). In another embodiment, a gas mixture as described herein may enable creaming of a beverage while creating a foam layer on top simultaneously (e.g., instant hybrid between a coffee creamer and a whipped cream topping). In another embodiment, a gas mixture as described herein may change the flavor of a foamed food product and a beverage or food product it is applied to (e.g., fruity notes to a non-fruity beverage). In another embodiment, a gas mixture as described herein may alter a foam food product, a beverage, and/or food product so that one or more of the foregoing modifications occur within the same product. For example, a gas mixture as described herein may provide a foam food product with foaming and creaming capabilities that is stable and that provides a beverage with fizziness, creaminess, flavor, and a foam topping.

As used herein, the term “sensory enhancement” refers to a product that enables consumers to experience multiple sensory experiences such as, smell, taste, mouthfeel, visual effect, etc. as a result of a mixed gas composition as described herein that are not commonly experienced without the mixed gas composition.

Unless otherwise defined herein, scientific and technical terms used in connection with the present disclosure shall have the meanings that are commonly understood by those of ordinary skill in the art. For example, any nomenclatures used in connection with, and techniques of, biology, biochemistry, chemistry, food science, and physics described herein are those that are well known and commonly used in the art. The meaning and scope of the terms should be clear; in the event however of any latent ambiguity, definitions provided herein take precedent over any dictionary or extrinsic definition. Further, unless otherwise required by context, singular terms shall include pluralities and plural terms shall include the singular.

### 2. Gas Mixtures

Provided herein are gas mixtures comprising at least two gases. The gases may be one or more of a noble gas, a greenhouse gas, air, or a diatomic gas. The gasses may be compressed gases or liquified gases. The gases may be two or more of N₂O, N₂, CO₂, Ar, He, and compressed air. The gas mixture may comprise two gases. The gas mixture may comprise a blend of: N₂O and N₂; N₂O and CO₂; N₂O and Ar; N₂O and He; N₂O and compressed air; N₂ and CO₂; N₂ and Ar; N₂ and He; N₂ and compressed air; CO₂ and Ar; CO₂ and He; CO₂ and compressed air; Ar and He; Ar and compressed air; or, He and compressed air. The gas mixture may comprise three gases. The gas mixture may comprise a blend of: N₂O, N₂, and CO₂; N₂O, N₂, and Ar; N₂O, N₂, and He; N₂O, N₂, and compressed air; N₂O, CO₂, and Ar; N₂O, CO₂, and He; N₂O, CO₂, and compressed air; N₂O, Ar, and He; N₂O, Ar, and compressed air; N₂O, He, and compressed air; N₂, CO₂, and Ar; N₂, CO₂, and He; N₂, CO₂, and compressed air; N₂, Ar, and He; N₂, Ar, and compressed air; N₂, He, and compressed air; CO₂, Ar, and He; CO₂, Ar, and compressed air; CO₂, He, and compressed air; or, Ar, He, and compressed air. The gas mixture may comprise four gases. The gas mixture may comprise a blend of: N₂O, N₂, CO₂, and Ar; N₂O, N₂, CO₂, and He; N₂O, N₂, CO₂, and compressed air; N₂O, CO₂, Ar, and He; N₂O, CO₂, Ar, and compressed air; N₂O, Ar, He, and compressed air; N₂, CO₂, Ar, and He; N₂, CO₂, Ar, and compressed air; N₂, Ar, He, and compressed air; or, CO₂, Ar, He, and compressed air. The gas mixture may comprise any of the above-described gas combinations along with any atmospheric air present in a container at the time of gas filling.

When the gas mixture comprises two gases, a first gas may be from about 5% to about 95% and a second gas may be from about 5% to about 95% of the gas mixture; a first gas may be from about 10% to about 90% and a second gas may be from about 10% to about 90% of the gas mixture; a first gas may be from about 15% to about 85% and a second gas may be from about 15% to about 85% of the gas mixture; a first gas may be from about 20% to about 80% and a second gas may be from about 20% to about 80% of the gas mixture; a first gas may be from about 30% to about 70% and a second gas may be from about 30% to about 70% of the gas mixture; or, a first gas may be from about 40% to about 60% and a second gas may be from about 40% to about 60% of the gas mixture. For example, the ratio of a first gas to a second gas may be about 5:95, about 50:50, or about 95:5. The gas ratios described above may also be present at said ratios in addition to any atmospheric air present in a container at the time of pressurization.

When the gas mixture comprises three gases, a first gas may be from about 5% to about 90%, a second gas may be from about 5% to about 90%, and a third gas may be from about 5% to about 90% of the gas mixture; a first gas may be from about 10% to about 80%, a second gas may be from about 10% to about 80%, and a third gas may be from about 10% to about 80% of the gas mixture; or, a first gas may be from about 20% to about 60%, a second gas may be from about 20% to about 60%, and a third gas may be from about 20% to about 60% of the gas mixture. For example, the ratio of a first gas to a second gas to a third gas may be about 90:5:5, about 5:90:5, about 5:5:90, or about 33:33:33. The gas ratios described above may also be present at said ratios in addition to any atmospheric air present in a container at the time of pressurization.

When the gas mixture comprises four gases, a first gas may be from about 5% to about 85%, a second gas may be from about 5% to about 85%, a third gas may be from about 5% to about 85%, and a fourth gas may be from about 5% to about 85% of the gas mixture; a first gas may be from about 10% to about 70%, a second gas may be from about 10% to about 70%, a third gas may be from about 10% to about 70%, and a fourth gas may be from about 10% to about 70% of the gas mixture; or, a first gas may be from about 20% to about 40%, a second gas may be from about 20% to about 40%, a third gas may be from about 20% to about 40%, and a fourth gas may be from about 20% to about 40% of the gas mixture. For example, the ratio of a first gas to a second gas to a third gas to a fourth gas may be about 85:5:5:5, about 5:85:5:5, about 5:5:85:5, about 5:5:5:85, or about 25:25:25:25. The gas ratios described above may also be present at said ratios in addition to any atmospheric air present in a container at the time of pressurization.

A first gas may be N₂O, N₂, CO₂, Ar, He, or compressed air. A second gas is a gas that is different from the first gas. A second gas may be N₂O, N₂, CO₂, Ar, He, or compressed air. A third gas is a gas that is different from the first and second gases. A third gas may be N₂O, N₂, CO₂, Ar, He, or compressed air. A fourth gas is a gas that is different from the first, second, and third gases. A fourth gas may be N₂O, N₂, CO₂, Ar, He, or compressed air. The gas mixtures may comprise any of the above-described gas combinations along with any atmospheric air present in a container at the time of gas filling.

A gas mixture as described herein may be comprised in a pressurized container (e.g., pressure resistant plastic container, metal container, aluminum container, steel container, or any other container made of any material that would support pressurization). The pressurized container may also comprise a liquid or semi-solid food product. The container may be a pressure-resistant container with a single chamber. The container may be a pressure-resistant container with dual chamber. The container may comprise a base, a sidewall, a valve, and an actuator. The container may comprise one or more inner receptacle(s) within the outer housing of said container. The container may comprise a tube extending within the outer housing to enable passage of liquid solvent concentrate or active component(s). The valve may be fluidly connected to a nozzle to allow for expelling the contents of the container.

### 3. Methods of Modifying a Foam Food Product

Provided herein are methods of modifying a foam food product. The methods may include mixing a gas mixture as described herein and a liquid food product in a container thereby dissolving a first portion of the gas mixture into the liquid food product and forming a foamable food product. From about 0.002% to about 50%, from about 0.1% to about 50%, from about 1% to about 50%, from about 5% to about 50%, from about 10% to about 50%, from about 15% to about 50%, from about 20% to about 50%, from about 30% to about 50%, from about 40% to about 50%, from about 0.002% to about 40%, from about 0.002% to about 30%, from about 0.002% to about 20%, from about 0.002% to about 15%, from about 0.002% to about 10%, from about 0.002% to about 5%, or from about 0.002% to about 1% of the gas mixture may be dissolved into the liquid food product.

The method may further include expelling the foamable food product from the container, wherein the food product expands to form the foam food product. Expelling the foamable food product from the container may comprise activating the valve of the container and expelling the foamable food product from the container through the nozzle. The mixing of a gas mixture and a liquid food product may comprise filling a first portion of a container as described herein with a liquid food product and filling a second portion of the container with the gas mixture, thereby pressurizing the container. The second portion may also be occupied with atmospheric air that is compressed when a gas mixture as described herein is added to the container. The first portion of the container may be from about 5% to about 95%, from about 5% to about 90%, from about 5% to about 80%, from about 5% to about 70%, from about 5% to about 60%, from about 5% to about 50%, from about 5% to about 40%, from about 5% to about 30%, from about 5% to about 20%, from about 5% to about 10%, from about 30% to about 90%, from about 30% to about 80%, from about 30% to about 70%, from about 30% to about 60%, from about 30% to about 50%, from about 30% to about 40%, from about 10% to about 95%, from about 20% to about 95%, from about 30% to about 95%, from about 40% to about 95%, from about 50% to about 95%, from about 60% to about 95%, from about 70% to about 95%, from about 80% to about 95%, from about 90% to about 95%, from about 40% to about 90%, from about 50% to about 90%, from about 60% to about 90%, from about 70% to about 90%, or from about 80% to about 90% of the container. The second portion of the container may be from about 10% to about 95%, from about 20% to about 95%, from about 30% to about 95%, from about 40% to about 95%, from about 50% to about 95%, from about 60% to about 95%, from about 70% to about 95%, from about 80% to about 95%, from about 90% to about 95%, from about 10% to about 70%, from about 20% to about 70%, from about 30% to about 70%, from about 40% to about 70%, from about 50% to about 70%, from about 60% to about 70%, from about 5% to about 95%, from about 5% to about 90%, from about 5% to about 80%, from about 5% to about 70%, from about 5% to about 60%, from about 5% to about 50%, from about 5% to about 40%, from about 5% to about 30%, from about 5% to about 20%, from about 5% to about 10%, from about 10% to about 60%, from about 10% to about 50%, from about 10% to about 40%, from about 10% to about 30%, or from about 10% to about 20% of the container. The container may be pressurized to a total pressure of from about 0 psi to about the bursting pressure of the container. The bursting pressure of a container may vary based on the container used. Typically, in the art, a bursting pressure may be about 220 psi to about 240 psi. The modification of the foam food product is dependent on the pressure in the container.

A second portion of the gas mixture may occupy space in the container that is unoccupied by the foamable food product thereby acting as a propellent. Thus, a gas mixture as described herein may act both as a modifier of the foam food product and a propellant for expelling the foamable food product from the container and forming the foam food product. The foamable food product expands to form the foam food product upon expulsion from the container. At least a portion of the second portion of the gas mixture may be dissolved and/or dispersed into the foamable food product by shaking the container. It is not required that the container be shaken to expel the foamable food product. The container may be inverted, and the valve of the container activated to expel the foamable food product from the container through the nozzle.

The liquid food product may be a dairy product, a non-dairy product, anhydrous, or hydrous. The liquid food product may comprise one or more of a fat, a protein, a carbohydrate, a water phase, a sweetener, a preservative, a flavoring, a surfactant, an emulsifier, a thickener, an inert particle, or a stabilizer. A fat, a protein, a carbohydrate, a water phase, a sweetener, a preservative, a flavoring, a surfactant, an emulsifier, a thickener, an inert particle, and a stabilizer may be any of such constituents known in the art. The liquid food product may be any liquid food product capable of forming a foam food product when mixed with a gas mixture as described herein, such as a dairy cream, a non-diary cream, milk, coffee creamer, half and half, non-dairy creamer, coffee extract, coffee solids dissolved in water, juice, juice concentrates, water, flavored liquid systems, tea extracts, tea solids dissolved in water, or any combinations thereof.

The foam food product may have one or more of the following characteristics: an overrun of from about 10% to about 600%; a bubble size of from about 3 pm to about 1 in; 0 min to 5 min for bubbles to coalesce; 0 min to 10 min for a 50% reduction in foam volume; a drainage rate (i.e., the time it takes for the continuous liquid phase in the foam system to fall away from the foam and interact with a beverage or food product) of from about 0 grams per second (g/sec) to about 100 g/sec; 0 cm to 5 cm foam height; a specific gravity of from about 0.1 g/cm³ to about 0.5 g/cm³; or, 0% to 100% solubility in a beverage. For example, a gas mixture comprising 90% N₂ and 10% NO₂ would have an overrun of about 10% to about 100%, would take about 0 min to about 1 min for bubbles to coalesce, and would have a drainage rate of about 80 g/sec to about 100 g/sec; whereas a gas mixture comprising 90% NO₂ and 10% N₂ would have an overrun of about 400% to about 600%, would take about 4 min to about 5 min for bubbles to coalesce, and would have a drainage rate of about 0 g/sec to about 5 g/sec.

### 4. Methods of Modifying a Beverage or Food Product

Provided herein are methods of modifying a beverage or food product. The method may comprise mixing a gas mixture as described herein and a liquid food product as described herein in a container as described herein thereby dissolving a first portion of the gas mixture into the liquid food product and forming a foamable food product. The method may further comprise applying the foamable food product to the beverage or food product by expelling the foamable food product from the container, wherein the foamable food product expands to form a foam food product wherein a first portion of the foam food product remains on the surface of the beverage or food product and a second portion of the foam food product either drains (e.g., the foam food product runs through the beverage or food product and settles at the bottom of a container comprising the beverage or food product) from the foam on the surface of the beverage or food product into the beverage or food product; and/or dissolves and/or disperses with the beverage or food product as a result of the expulsion velocity (e.g., the foam food product may be forced into the beverage or food product causing the foam food product to dissolve and/or disperse into the beverage or food product). From about 0% to about 100% of the foam food product may remain on the surface of the beverage or food product to which it was applied (i.e., the first portion of the foam food product may be from about 0% to about 100% of the foam food product). From about 0% to about 100% of the foam food product may drain, dissolve, and/or disperse into the beverage or food product to which it was applied (i.e., the second portion of the foam food product may be from about 0% to about 100% of the foam food product). The speed at which the foam food product drains, dissolves, and/or disperses into a beverage or food product over time can be accelerated or decelerated. For example, the foam food product may partially drain, dissolve, and/or disperse into the beverage or food product instantly or the foam food product may drain, dissolve, and/or disperse entirely into the beverage or food product immediately upon application thereto. The second portion of the foam food product may provide sensory enhancement of the beverage or food product by altering the beverage's or food product's flavor, texture, color, or a combination thereof. The amount of the first portion of the foam food product and the amount of the second portion of the foam food product that interact with the beverage or food product, or that remain on top of the beverage or food product may depend on the composition of the gas mixture, the pressure inside the container, the physico-chemical properties of the liquid food product in the container, the physico-chemical properties of the beverage or food product, or a combination thereof.

The amount of the foam food product that is drained, dispersed, and/or dissolved into a beverage or food product and speed at which it occurs may be increased or decreased depending on the ratio and composition of gases used as well as the pressure of the container. For example, whitening (i.e., color change from dispersion of the foam food product in a beverage or food product) of a beverage or food product may be maximized when gases that are the least soluble in a beverage or food product are used at the highest pressure: a gas mixture comprising 70% N₂ and 30% NO₂ would whiten a beverage product faster than a gas mixture comprising a 50/50 blend of the gases; and, a gas mixture comprising 90% N₂ and 10% NO2 would whiten a beverage product faster than a 70/30 blend of the gases. The amount of the foam food product that remains on the surface of the beverage or food product (i.e., “foam layer” or “floating foam”) may be increased or decreased depending on the ratio and composition of gases used, as well as the pressure of the container. For example, the foam layer may be maximized when gases that are the most soluble in a beverage or food product are used at the highest pressure: a foam comprising a gas mixture comprising 70% NO2 and 30% N₂ would remain on the surface of a beverage product longer than a 50/50 blend of the gases; and, a foam comprising a gas mixture comprising 90% NO₂ and 10% N₂ would remain on the surface of a beverage product longer than a 70/30 blend of the gases. The more soluble a gas is in the liquid food product used for foaming, the greater the degree of bubbles formed in the expelled and subsequently expanded foam food product.

The beverage or beverage product as described herein may be a liquid, semi-solid, or mixture of solid particles in a liquid base. The beverage product may be one or more of a coffee, a tea, a juice, a milk, a chocolate milk, a smoothie, a milkshake, a shake, a soft drink, water, a flavored water, an alcoholic beverage, a mocktail, an energy drink, cocoa, or other beverage emulsions.

The food product may be a liquid, semi-solid, or solid. The food product may be one or more of cake, meat, crepes, a soup, a broth, and the like.

### 5. Examples

The foregoing may be better understood by reference to the following examples, which are presented for purposes of illustration and are not intended to limit the scope of the invention. The present disclosure has multiple aspects and embodiments, illustrated by the appended non-limiting examples.

### Example 1

### Effects of Nitrogen to Nitrous Oxide Ratio of Pressurized Foamable Fluids on Foam Properties and Beverage Interaction

### A. Methods

Gas mixtures comprising N₂ and N₂O at ratios of 0:100, 30:70, 50:50, 70:30, and 100:0 were tested. For repetition purposes, a commercial non-dairy product was purchased from the grocery store for all testing. A 2-piece Litho aerosol can with a 22 oz volumetric capacity was used. Each can was filled with 15.5 oz by wt. of product and pressurized to a total pressure of 130 pounds per square inch (psi).

Density. Pressurized aerosol cans were shaken 10 times, inverted to a vertical position, and the actuator was compressed to a maximum angle. Foam was then expelled directly from the pressurized aerosol cans into a tared stainless-steel cylinder (87.09 mL). Any excess foam was scraped off using a metal spatula to even the foam height with the top of the weighing cylinder and the foam was then weighed. Weights were collected from the first four expulsions of two cans. Density was calculated according to the following equation:

$$Density = \frac{Foam Weight ( g )}{Cylinder Volume ( mL )} .$$

Overrun. Data collected for the foam density measurements were used to calculate the percent overrun according to the following equation:

$$\% Overrun = \frac{\begin{matrix}( wt . 87.09 mL Foamable Liquid ) - \\ ( wt . 87.09 mL Foam )\end{matrix}}{( wt . 87.09 mL Foam )} \times 10 \; 0 .$$

Yield Stress. Foam yield stress was measured by the single point vane method (See: James Freeman Steffe, “Rheological methods in food process engineering,” Freeman Press (1996)) using a Brookfield DV-III+ Pro Viscometer RV (Brookfield Engineering Laboratories Inc., Stoughton, MA) with a vane spindle attachment. The viscometer rpm was set to 0.3 and the maximum % torque was recorded. At 100% torque, the RV spring force was 0.7187 milli Newton-meters (Nm). The maximum % torque was converted to Newton-meters for yield stress calculations according to the following equation:

$${σ}_{o} = \frac{2 {M}_{0}}{π {d}^{3}} {( \frac{h}{d} + \frac{1}{3} )}^{- 1} ,$$

where σ₀=Yield Stress (Pa); M₀=Maximum Torque (N·m); d=Vane Diameter (m); and h=Vane Height (m). All samples were measured within 30 sec of expulsion from the aerosol can. The first three expulsions of two cans were used to measure yield stress.

Foam Drainage. Foam drainage was measured as an indicator of foam stability. 100 g of foam was expelled into a bowl with a 0.6 cm hole at the bottom. The weight of the liquid drained from the foam was measured at 1, 5, and 10 minutes. The percent drainage was calculated according to the following equation:

$$\% Drainage = \frac{( wt . of Foam ) - ( wt . of Drained Fluid )}{( wt . of foam )} \times 100.$$

Foam to Beverage Ratio. Cold brew coffees with cold foam typically have a 4:1 weight ratio. To understand the impact of the nitrogen to nitrous oxide ratio on the foam properties of a foamable fluid in a beverage application, 12.5 g of foam was expelled into 50 g of cold brew coffee in a 100 mL graduated cylinder. The foam-cold brew interface (FI), liquid volume (LV), and foam volume (FV) were determined after 1, 5, and 10 minutes of interaction. The foam volume was determined as the total volume (foam volume plus liquid volume) minus the liquid volume. The liquid volume was determined as the interface volume. The first three expulsions of two cans were used for beverage interaction measurements. The foam to beverage ratio was determined according to the following equation:

$$Foam to Beverage Ratio = \frac{FV}{LV} .$$

Foam Drainage in Beverage. As liquid drains from the foam into the beverage, the liquid volume of the beverage below the foam increases. Foam drainage into the beverage was taken as the change in liquid interface volume. The first three expulsions of two cans were used for beverage interaction measurements.

### B. Foam Properties

A comparison of foam properties including overrun, density, yield stress, and stability over time enabled the differentiation of foams aerosolized by pressurization with different ratios of nitrogen (N₂) to nitrous oxide (NO₂) (Table 1).

TABLE 1
Properties of foams generated with foamable fluid
pressurized to 130 psi with N₂:N₂O gas blends.

| Ratio of | | | | Yield | % Drainage | | |
|---|---|---|---|---|---|---|---|
| N₂:N₂O | | Density | % | Stress of | 1 | 5 | 10 |
| at 130 psi | | (g/mL) | Overrun | Foam (Pa) | min | min | min |
| 0:100 | AVG | 0.22 | 414.26 | 50.52 | 0.00 | 1.52 | 14.82 |
| (100% N₂O) | std. | 0.00 | 5.79 | 2.33 | 0.00 | 1.28 | 8.81 |
| | dev. | | | | | | |
| 30:70 | AVG | 0.29 | 283.77 | 23.50 | 0.08 | 7.76 | 31.49 |
| | std. | 0.00 | 0.99 | 0.39 | 0.01 | 3.85 | 9.21 |
| | dev. | | | | | | |
| 50:50 | AVG | 0.37 | 208.47 | 9.20 | 14.00 | 74.89 | 82.02 |
| | std. | 0.02 | 15.76 | 0.48 | 0.91 | 8.92 | 8.02 |
| | dev. | | | | | | |
| 70:30 | AVG | 0.55 | 104.34 | 4.77 | 86.54 | N/A | N/A |
| | std. | 0.00 | 5.96 | 0.17 | 3.78 | | |
| | dev. | | | | | | |
| 100:0 | AVG | 0.76 | 48.08 | N/A | N/A | N/A | N/A |
| (100% N₂) | std. | 0.00 | 0.51 | | | | |
| | dev. | | | | | | |

*N/A indicates that data were not obtainable.

As shown above in Table 1, shifting the gas system from 100% nitrogen to 100% nitrous oxide was found to increase the expelled fluid's overrun from 48% to 414%. In addition, increasing the overrun with more nitrous oxide reduced the foam density. There was an inverse relationship between foam density and yield stress, where low density foams exhibited a higher yield stress. In food products, yield stress is highly correlated with sensory attributes of stiffness or firmness. See: Adriano Sun and Sundaram Gunasekaran, “Yield stress in foods: measurements and applications,” International Journal of Food Properties 12(1): 70-101 (2009), Thus, shifting the gas blend led to changes in the textural attributes of the foam (Table 1).

The stiffer foams having higher levels of nitrous oxide had greater stability over time in that the fluid fraction drained through the lamella more slowly. Once released from the foam, the fluid fraction was then free to interact with the beverage or food upon which it is sitting, For the treatment with 100% nitrogen, the foam generated was too small to attain any reasonable measurement for yield stress or % drainage. Taken as a whole, by shifting the ratio of gasses present with different degrees of solubility, the foam texture and foam stability attributes may be fine-tuned and/or tailored for a targeted application.

### C. Beverage Modification

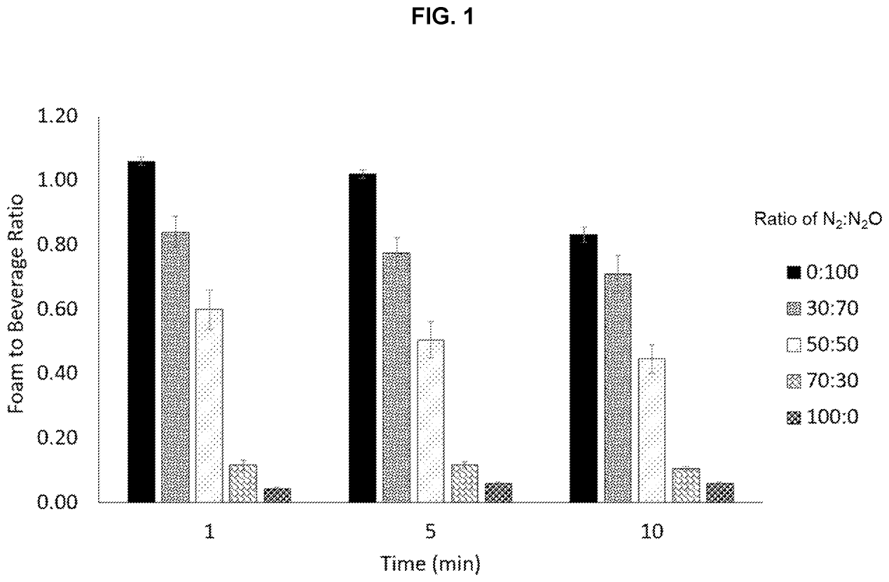

Once a pressurized foamable fluid is expelled into a beverage, a new beverage system can be created by adjusting the gas blends, which alters the fluid to foam ratio, the degree of turbulent interaction with the beverage upon expulsion, and the flavoring rate of the foam via drainage of fluid from the foam. The overrun of a foamable liquid shifts as the amount of nitrous oxide (a soluble gas) present in the pressurized vessel shifts (Table 1). In application, this trend enables the modification of a beverage by altering the foam to fluid ratio of the beverage system (FIG. 1).

In this example, a foamable fluid was expelled into cold brew coffee. FIG. 1 shows the effect of different N₂:N₂O gas ratios on the ratio of non-dairy creamer foam to fluid cold brew coffee beverage over time. It was found that shifting the N₂:N₂O gas ratio enabled the creation of beverages having features that ranged from cappuccino to latte to flat white froth.

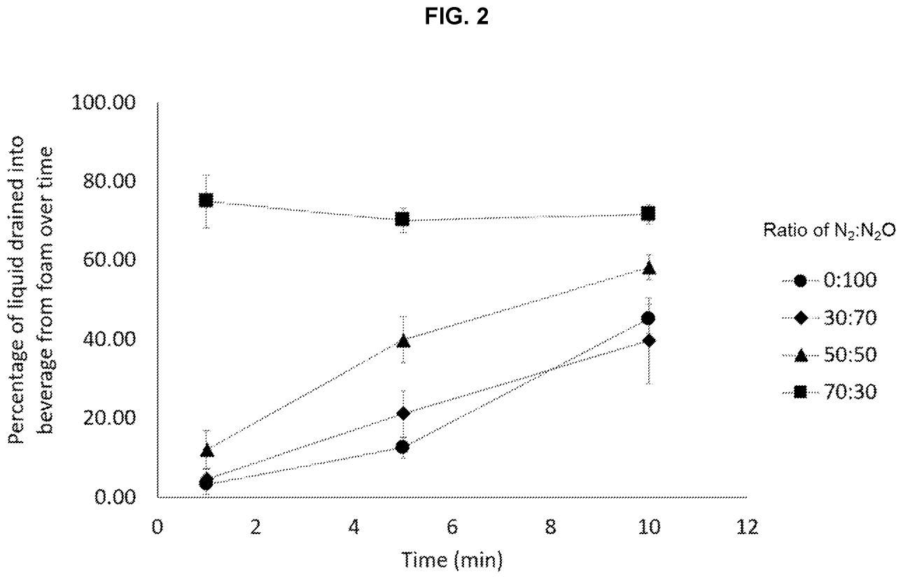

Foam stability can be defined in terms of the rate at which the fluid fraction of the foam drains through the foam lamella. Once released from the foam, the fluid fraction is then free to interact with a beverage or food upon which it is sitting. By shifting the blended gas ratio from 100% nitrous oxide to 100% nitrogen, the rate at which the fluid fraction of the foam interacted with the beverage system was increased (FIG. 2). This further contributed to the beverage modification by increasing color and flavor of the fluid fraction of the beverage system. This drainage into the beverage changes the beverage system over time. After five minutes of beverage interaction, it was observed that roughly 13% of the foamable fluid weight had drained into the fluid beverage for treatments with 100% nitrous oxide (FIG. 2). Additionally, increasing the nitrogen content increased the amount of fluid that drained from the foam into the liquid beverage portion by nearly 70% of the foam weight (FIG. 2).

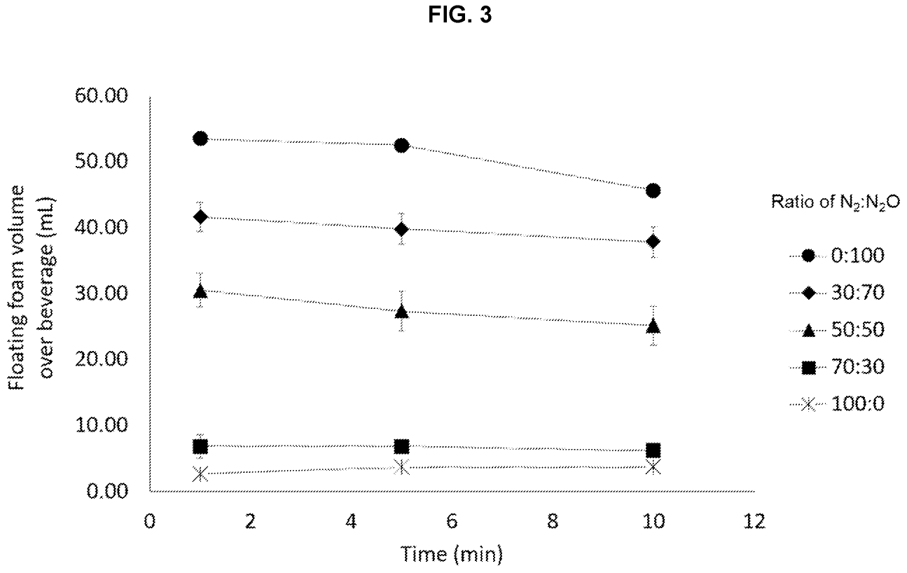

Despite the increasing loss of fluid from the foam, the measured floating foam volume over beverage showed a subtle change over time (FIG. 3). For example, the foam volume decreased from 54 mL to 53 mL, 42 mL to 40 mL, 31 mL to 27 mL, and remained constant at 7 mL for foam treatments with N₂:N₂O gas ratios of 0:100, 30:70, 50:50, and 70:30, respectively (FIG. 3). Taken as a whole, these data indicate that the fluid fraction of the beverage system may be modified with different gas treatment blends while minimally altering the floating foam volume.

Nitrogen gas is a commonly used propellent of food products in the aerosol industry. With low solubility in water, a higher proportion of the gas remains in the headspace than is dissolved in a foamable fluid. As the mass of nitrogen gas in the headspace increases, the rate at which the fluid is expelled from the pressurized vessel also increases. When applied into beverage systems, this increased expulsion rate increases the degree of turbulent mixing action in the beverage. Thus, by controlling the propellent content of the pressurized vessel, the degree of beverage modification can be tailored to a desired outcome and application.

### Example 2

### Additional Mixed Gas Food Applications

Gas mixtures comprising N₂O, N₂, CO₂, Ar, He, and/or compressed air are tested. For repetition purposes, a commercial dairy product and non-dairy product are purchased from the grocery store for all testing. A 2-piece Litho aerosol can with a 22 oz volumetric capacity is used. Each can is filled with 15.5 oz by wt. of product and pressurized to a total pressure of between 60 and 180 psi. For organoleptic evaluation, 20 g±3 g of product is dispensed over 7 oz of a commercial cold brew coffee product.

For each base (dairy and non-dairy), cans are pressurized with a single gas to establish baseline characteristics (i.e., control). Next, 50:50 ratios are evaluated with 2 gasses at a time to determine differences compared to the control. 15 blends are used: N₂O and N₂; N₂O and CO₂; N₂O and Ar; N₂O and He; N₂O and compressed air; N₂ and CO₂; N₂ and Ar; N₂ and He; N₂ and compressed air; CO₂ and Ar; CO₂ and He; CO₂ and compressed air; Ar and He; Ar and compressed air; and, He, and compressed air. Then, 33:33:33 ratios are used with 3 gasses at a time to determine if there are any differences compared to the control. 20 blends are used: N₂O, N₂, and CO₂; N₂O, N₂, and Ar; N₂O, N₂, and He; N₂O, N₂, and compressed air; N₂O, CO₂, and Ar; N₂O, CO₂, and He; N₂O, CO₂, and compressed air; N₂O, Ar, and He; N₂O, Ar, and compressed air; N₂O, He, and compressed air; N₂, CO₂, and Ar; N₂, CO₂, and He; N₂, CO₂, and compressed air; N₂, Ar, and He; N₂, Ar, and compressed air; N₂, He, and compressed air; CO₂, Ar, and He; CO₂, Ar, and compressed air; CO₂, He, and compressed air; and, Ar, He, and compressed air. Then, 25:25:25:25 ratios are used with 4 gasses at a time to determine if there are any differences compared to the control. 10 blends are used: N₂O, N₂, CO₂, and Ar; N₂O, N₂, CO₂, and He; N₂O, N₂, CO₂, and compressed air; N₂O, CO₂, Ar, and He; N₂O, CO₂, Ar, and compressed air; N₂O, Ar, He, and compressed air; N₂, CO₂, Ar, and He; N₂, CO₂, Ar, and compressed air; N₂, Ar, He, and compressed air; and, CO₂, Ar, He, and compressed air.

The following variables are analyzed for each condition: percent overrun, bubble size, presence/absence of coalescence or time it takes for bubbles to coalesce, foam stability (time required for a 50% reduction in foam volume), creaming of coffee via colorimeter, drainage rate, specific gravity, height of foam, measurement of solubility, and organoleptic evaluation.

The foregoing description of the specific aspects will so fully reveal the general nature of the invention that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

For reasons of completeness, various aspects of the invention are set out in the following numbered clauses:

Clause 1. A method of modifying a beverage or food product, comprising: in a container, mixing two or more gases and a liquid food product thereby dissolving a portion of the gas mixture into the liquid food product and forming a foamable food product; applying the foamable food product to the beverage or food product by expelling the foamable food product from the container, wherein the foamable food product expands to form a foam food product wherein a first portion of the foam food product remains on the surface of the beverage or food product and a second portion of the foam food product dissolves, disperses, and/or drains into the beverage or food product.

Clause 2. The method of clause 1, wherein the amount of the first portion of the foam food product and the amount of the second portion of the foam food product depends on the composition of the gas mixture, the pressure inside the container, or a combination thereof.

Clause 3. The method of clause 1 or clause 2, wherein the second portion of the foam food product adds flavor to the beverage or food product, modifies the texture of the beverage or food product, modifies the color of the beverage or food product, or a combination thereof.

Clause 4. The method of any one of clauses 1-3, wherein the beverage or food product is one or more of a coffee, a tea, a juice, a milk, a smoothie, a milkshake, a soft drink, water, a flavored water, an alcoholic beverage, a mocktail, a soup, a broth, cocoa, cake, meat, crepes.

Clause 5. A method of modifying the texture of a foam food product, comprising: in a container, mixing a gas mixture comprising two or more gases with a liquid food product thereby dissolving a first portion of the gas mixture into the liquid food product and forming a foamable food product; expelling the foamable food product from the container, wherein the foamable food product expands to form the foam food product.

Clause 6. The method of any one of clauses 1-5, wherein the mixing of two or more gases and a liquid food product comprises filling a first portion of a container with a liquid food product and filling a second portion of the container with the gas mixture, thereby pressurizing the container.

Clause 7. The method of any one of clauses 1-6, wherein a second portion of the gas mixture occupies space in the container unoccupied by the foamable food product thereby acting as a propellent.

Clause 8. The method of any one of clauses 1-7, wherein the container is a pressure-resistant container with either single or dual internal chamber comprising a base, a sidewall, and a valve.

Clause 9. The method of clause 8, wherein expelling the foamable food product from the container comprises activating the valve of the container and expelling the foamable food product from the container through a nozzle.

Clause 10. The method of any one of clauses 7-9, wherein at least a portion of the second portion of the gas mixture is dissolved into the foamable food product by shaking the container to expel the foamable food product from the container.

Clause 11. The method of any one of clauses 1-10, wherein the two or more gases are selected from the group consisting of nitrous oxide (N₂O), nitrogen (N₂), carbon dioxide (CO₂), argon (Ar), helium (He), and compressed air.

Clause 12. The method of clause 11, wherein when the gas mixture comprises two gases, a first gas is from about 5% to about 95% and a second gas is from about 5% to about 95% of the gas mixture.

Clause 13. The method of clause 11, wherein when the gas mixture comprises three gases, a first gas is from about 5% to about 90%, a second gas is from about 5% to about 90%, and a third gas is from about 5% to about 90% of the gas mixture.

Clause 14. The method of clause 11, wherein when the gas mixture comprises four gases, a first gas is from about 5% to about 85%, a second gas is from about 5% to about 85%, a third gas is from about 5% to about 85%, and a fourth gas is from about 5% to about 85% of the gas mixture.

Clause 15. The method of clause 11 or clause 12, wherein the gas mixture comprises a blend of: N₂O and N₂; N₂O and CO₂; N₂O and Ar; N₂O and He; N₂O and compressed air; N₂ and CO₂; N₂ and Ar; N₂ and He; N₂ and compressed air; CO₂ and Ar; CO₂ and He; CO₂ and compressed air; Ar and He; Ar and compressed air; or, He and compressed air.

Clause 16. The method of clause 11 or clause 13, wherein the gas mixture comprises a blend of: N₂O, N₂, and CO₂; N₂O, N₂, and Ar; N₂O, N₂, and He; N₂O, N₂, and compressed air; N₂O, CO₂, and Ar; N₂O, CO₂, and He; N₂O, CO₂, and compressed air; N₂O, Ar, and He; N₂O, Ar, and compressed air; N₂O, He, and compressed air; N₂, CO₂, and Ar; N₂, CO₂, and He; N₂, CO₂, and compressed air; N₂, Ar, and He; N₂, Ar, and compressed air; N₂, He, and compressed air; CO₂, Ar, and He; CO₂, Ar, and compressed air; CO₂, He, and compressed air; or, Ar, He, and compressed air.

Clause 17. The method of clause 11 or clause 14, wherein the gas mixture comprises a blend of: N₂O, N₂, CO₂, and Ar; N₂O, N₂, CO₂, and He; N₂O, N₂, CO₂, and compressed air; N₂O, CO₂, Ar, and He; N₂O, CO₂, Ar, and compressed air; N₂O, Ar, He, and compressed air; N₂, CO₂, Ar, and He; N₂, CO₂, Ar, and compressed air; N₂, Ar, He, and compressed air; or, CO₂, Ar, He, and compressed air.

Clause 18. The method of any one of clauses 1-17, wherein from about 0.002% to about 50% of the gas mixture is dissolved into the liquid food product.

Clause 19. The method of any one of clauses 6-18, wherein the first portion of the container is from about 30% to about 90% of the container.

Clause 20. The method of any one of clauses 6-19, wherein the second portion of the container is from about 10% to about 70% of the container.

Clause 21. The method of any one of clauses 6-20, wherein the container is pressurized to a total pressure of from about 0 psi to about the bursting pressure of the container.

Clause 22. The method of any one of clauses 1-21, wherein the foam food product has one or more of the following characteristics: an overrun of from about 10% to about 600%; a bubble size of from about 3 μm to about 1 in; 0 min to 5 min for bubbles to coalesce; 0 min to 10 min for a 50% reduction in foam volume; a drainage rate of from about 0 g/sec to about 100 g/sec; 0 cm to 5 cm foam height; a specific gravity of from about 0.1 g/cm³ to about 0.5 g/cm³; and, 0% to 100% solubility in a beverage.

Clause 23. A gas mixture for improving the texture of a foam food product, a beverage, or a combination thereof, comprising at least two gases selected from the group consisting of nitrous oxide (N₂O), nitrogen (N₂), carbon dioxide (CO₂), argon (Ar), helium (He), and compressed air.

Clause 24. The gas mixture of clause 23, wherein when the gas mixture comprises two gases, a first gas is from about 5% to about 95% and a second gas is from about 5% to about 95% of the gas mixture.

Clause 25. The gas mixture of clause 23, wherein when the gas mixture comprises three gases, a first gas is from about 5% to about 90%, a second gas is from about 5% to about 90%, and a third gas is from about 5% to about 90% of the gas mixture.

Clause 26. The gas mixture of clause 23, wherein when the gas mixture comprises four gases, a first gas is from about 5% to about 85%, a second gas is from about 5% to about 85%, a third gas is from about 5% to about 85%, and a fourth gas is from about 5% to about 85% of the gas mixture.

Clause 27. The gas mixture of clause 23 or clause 24, wherein the gas mixture comprises a blend of: N₂O and N₂; N₂O and CO₂; N₂O and Ar; N₂O and He; N₂O and compressed air; N₂ and CO₂; N₂ and Ar; N₂ and He; N₂ and compressed air; CO₂ and Ar; CO₂ and He; CO₂ and compressed air; Ar and He; Ar and compressed air; or, He and compressed air.

Clause 28. The gas mixture of clause 23 or clause 25, wherein the gas mixture comprises a blend of: N₂O, N₂, and CO₂; N₂O, N₂, and Ar; N₂O, N₂, and He; N₂O, N₂, and compressed air; N₂O, CO₂, and Ar; N₂O, CO₂, and He; N₂O, CO₂, and compressed air; N₂O, Ar, and He; N₂O, Ar, and compressed air; N₂O, He, and compressed air; N₂, CO₂, and Ar; N₂, CO₂, and He; N₂, CO₂, and compressed air; N₂, Ar, and He; N₂, Ar, and compressed air; N₂, He, and compressed air; CO₂, Ar, and He; CO₂, Ar, and compressed air; CO₂, He, and compressed air; or, Ar, He, and compressed air.

Clause 29. The gas mixture of clause 23 or clause 26, wherein the gas mixture comprises a blend of: N₂O, N₂, CO₂, and Ar; N₂O, N₂, CO₂, and He; N₂O, N₂, CO₂, and compressed air; N₂O, CO₂, Ar, and He; N₂O, CO₂, Ar, and compressed air; N₂O, Ar, He, and compressed air; N₂, CO₂, Ar, and He; N₂, CO₂, Ar, and compressed air; N₂, Ar, He, and compressed air; or, CO₂, Ar, He, and compressed air.

Clause 30. A pressurized container comprising: a gas mixture comprising two or more gases selected from the group consisting of nitrous oxide (N₂O), nitrogen (N₂), carbon dioxide (CO₂), argon (Ar), helium (He), and compressed air; and a liquid food product.

Clause 31. The pressurized container of clause 30, wherein when the gas mixture comprises two gases, a first gas is from about 5% to about 95% and a second gas is from about 5% to about 95% of the gas mixture.

Clause 32. The pressurized container of clause 30, wherein when the gas mixture comprises three gases, a first gas is from about 5% to about 90%, a second gas is from about 5% to about 90%, and a third gas is from about 5% to about 90% of the gas mixture.

Clause 33. The pressurized container of clause 30, wherein when the gas mixture comprises four gases, a first gas is from about 5% to about 85%, a second gas is from about 5% to about 85%, a third gas is from about 5% to about 85%, and a fourth gas is from about 5% to about 85% of the gas mixture.

Clause 34. The pressurized container of clause 30 or clause 31, wherein the gas mixture comprises a blend of: N₂O and N₂; N₂O and CO₂; N₂O and Ar; N₂O and He; N₂O and compressed air; N₂ and CO₂; N₂ and Ar; N₂ and He; N₂ and compressed air; CO₂ and Ar; CO₂ and He; CO₂ and compressed air; Ar and He; Ar and compressed air; or, He and compressed air.

Clause 35. The pressurized container of clause 30 or clause 32, wherein the gas mixture comprises a blend of: N₂O, N₂, and CO₂; N₂O, N₂, and Ar; N₂O, N₂, and He; N₂O, N₂, and compressed air; N₂O, CO₂, and Ar; N₂O, CO₂, and He; N₂O, CO₂, and compressed air; N₂O, Ar, and He; N₂O, Ar, and compressed air; N₂O, He, and compressed air; N₂, CO₂, and Ar; N₂, CO₂, and He; N₂, CO₂, and compressed air; N₂, Ar, and He; N₂, Ar, and compressed air; N₂, He, and compressed air; CO₂, Ar, and He; CO₂, Ar, and compressed air; CO₂, He, and compressed air; or, Ar, He, and compressed air.

Clause 36. The pressurized container of clause 30 or clause 33, wherein the gas mixture comprises a blend of: N₂O, N₂, CO₂, and Ar; N₂O, N₂, CO₂, and He; N₂O, N₂, CO₂, and compressed air; N₂O, CO₂, Ar, and He; N₂O, CO₂, Ar, and compressed air; N₂O, Ar, He, and compressed air; N₂, CO₂, Ar, and He; N₂, CO₂, Ar, and compressed air; N₂, Ar, He, and compressed air; or, CO₂, Ar, He, and compressed air.

Clause 37. The pressurized container of any one of clauses 30-36, wherein the container is a single chamber pressure-resistant container or a dual chamber pressure-resistant container comprising a base, a sidewall, and a valve.

Clause 38. The pressurized container of any one of clauses 30-37, wherein the container is pressurized to a total pressure of from about 0 psi to about the bursting pressure of the container.

1. A method of modifying a beverage or food product, comprising:
in a container, mixing two or more gases and a liquid food product thereby dissolving a portion of the gas mixture into the liquid food product and forming a foamable food product;
applying the foamable food product to the beverage or food product by expelling the foamable food product from the container, wherein the foamable food product expands to form a foam food product wherein a first portion of the foam food product remains on the surface of the beverage or food product and a second portion of the foam food product dissolves, disperses, and/or drains into the beverage or food product.

2. The method of claim 1, wherein the amount of the first portion of the foam food product and the amount of the second portion of the foam food product depends on the composition of the gas mixture, the pressure inside the container, or a combination thereof.

3. The method of claim 1, wherein the second portion of the foam food product adds flavor to the beverage or food product, modifies the texture of the beverage or food product, modifies the color of the beverage or food product, or a combination thereof.

4. The method of claim 1, wherein the beverage or food product comprises one or more of a coffee, a tea, a juice, a milk, a smoothie, a milkshake, a soft drink, water, a flavored water, an alcoholic beverage, a mocktail, a soup, a broth, cocoa, cake, meat, or crepes.

5. A method of modifying the texture of a foam food product, comprising:
in a container, mixing a gas mixture comprising two or more gases with a liquid food product thereby dissolving a first portion of the gas mixture into the liquid food product and forming a foamable food product;
expelling the foamable food product from the container, wherein the foamable food product expands to form the foam food product.

6. The method of claim 5, wherein the mixing of two or more gases and a liquid food product comprises filling a first portion of a container with a liquid food product and filling a second portion of the container with the gas mixture, thereby pressurizing the container, and wherein the second portion of the gas mixture occupies space in the container unoccupied by the foamable food product, thereby acting as a propellent.

7. (canceled)

8. The method of claim 5, wherein the container is a pressure-resistant container with either single or dual internal chamber comprising a base, a sidewall, and a valve, wherein expelling the foamable food product from the container comprises dispersing at least a portion of the second portion of the gas mixture into the foamable food product by shaking the container and activating the valve of the container and expelling the foamable food product from the container through a nozzle.

9-10. (canceled)

11. The method of claim 5, wherein the two or more gases are selected from the group consisting of nitrous oxide (N₂O), nitrogen (N₂), carbon dioxide (CO₂), argon (Ar), helium (He), and compressed air.

12. The method of claim 11, wherein when the gas mixture comprises two gases, a first gas is from about 5% to about 95% and a second gas is from about 5% to about 95% of the gas mixture.,
wherein when the gas mixture comprises three gases, a first gas is from about 5% to about 90%, a second gas is from about 5% to about 90%, and a third gas is from about 5% to about 90% of the gas mixture: or
wherein when the gas mixture comprises four gases, a first gas is from about 5% to about 85%, a second gas is from about 5% to about 85%, a third gas is from about 5% to about 85%, and a fourth gas is from about 5% to about 85% of the gas mixture.

13-14. (canceled)

15. The method of claim 11, wherein the gas mixture comprises a blend of:
N₂O and N₂;
N₂O and CO₂;
N₂O and Ar;
N₂O and He;
N₂O and compressed air;
N₂ and CO₂;
N₂ and Ar;
N₂ and He;
N₂ and compressed air;
CO₂ and Ar;
CO₂ and He;
CO₂ and compressed air;
Ar and He;
Ar and compressed air; or,
He and compressed air.

16. The method of claim 11, wherein the gas mixture comprises a blend of:
N₂O, N₂, and CO₂;
N₂O, N₂, and Ar;
N₂O, N₂, and He;
N₂O, N₂, and compressed air;
N₂O, CO₂, and Ar;
N₂O, CO₂, and He;
N₂O, CO₂, and compressed air;
N₂O, Ar, and He;
N₂O, Ar, and compressed air;
N₂O, He, and compressed air;
N₂, CO₂, and Ar;
N₂, CO₂, and He;
N₂, CO₂, and compressed air;
N₂, Ar, and He;
N₂, Ar, and compressed air;
N₂, He, and compressed air;
CO₂, Ar, and He;
CO₂, Ar, and compressed air;
CO₂, He, and compressed air; or,
Ar, He, and compressed air.

17. The method of claim 11, wherein the gas mixture comprises a blend of:
N₂O, N₂, CO₂, and Ar;
N₂O, N₂, CO₂, and He;
N₂O, N₂, CO₂, and compressed air;
N₂O, CO₂, Ar, and He;
N₂O, CO₂, Ar, and compressed air;
N₂O, Ar, He, and compressed air;
N₂, CO₂, Ar, and He;
N₂, CO₂, Ar, and compressed air;
N₂, Ar, He, and compressed air; or, CO₂, Ar, He, and compressed air.

18. The method of claim 5, wherein from about 0.002% to about 50% of the gas mixture is dissolved into the liquid food product, wherein the first portion of the container is from about 30% to about 90% of the container, and wherein the second portion of the container is from about 10% to about 70% of the container.

19-20. (canceled)

21. The method of claim 5, wherein the container is pressurized to a total pressure of from about 0 psi to about the bursting pressure of the container.

22. The method of claim 5, wherein the foam food product has one or more of the following characteristics:
an overrun of from about 10% to about 600%;
a bubble size of from about 3 pm to about 1 in;
0 min to 5 min for bubbles to coalesce;
0 min to 10 min for a 50% reduction in foam volume;
a drainage rate of from about 0 g/sec to about 100 g/sec;
a specific gravity of from about 0.1 g/cm³ to about 0.5 g/cm³; and,
0% to 100% solubility in a beverage.

23. A gas mixture for improving the texture of a foam food product, a beverage, a food product, or a combination thereof, comprising at least two gases selected from the group consisting of nitrous oxide (N₂O), nitrogen (N₂), carbon dioxide (CO₂), argon (Ar), helium (He), and compressed air.

24. The gas mixture of claim 23, wherein when the gas mixture comprises two gases, a first gas is from about 5% to about 95% and a second gas is from about 5% to about 95% of the gas mixture., wherein when the gas mixture comprises three gases, a first gas is from about 5% to about 90%, a second gas is from about 5% to about 90%, and a third gas is from about 5% to about 90% of the gas mixture: or wherein when the gas mixture comprises four gases, a first gas is from about 5% to about 85%, a second gas is from about 5% to about 85%, a third gas is from about 5% to about 85%, and a fourth gas is from about 5% to about 85% of the gas mixture.

25-26. (canceled)

27. The gas mixture of claim 23, wherein the gas mixture comprises a blend of:
N₂O and N₂;
N₂O and CO₂;
N₂O and Ar;
N₂O and He;
N₂O and compressed air;
N₂ and CO₂;
N₂ and Ar;
N₂ and He;
N₂ and compressed air;
CO₂ and Ar;
CO₂ and He;
CO₂ and compressed air;
Ar and He;
Ar and compressed air; or,
He and compressed air.

28. The gas mixture of claim 23, wherein the gas mixture comprises a blend of:
N₂O, N₂, and CO₂;
N₂O, N₂, and Ar;
N₂O, N₂, and He;
N₂O, N₂, and compressed air;
N₂O, CO₂, and Ar;
N₂O, CO₂, and He;
N₂O, CO₂, and compressed air;
N₂O, Ar, and He;
N₂O, Ar, and compressed air;
N₂O, He, and compressed air;
N₂, CO₂, and Ar;
N₂, CO₂, and He;
N₂, CO₂, and compressed air;
N₂, Ar, and He;
N₂, Ar, and compressed air;
N₂, He, and compressed air;
CO₂, Ar, and He;
CO₂, Ar, and compressed air;
CO₂, He, and compressed air; or, Ar, He, and compressed air.

29. The gas mixture of claim 23 or claim 26, wherein the gas mixture comprises a blend of:
N₂O, N₂, CO₂, and Ar;
N₂O, N₂, CO₂, and He;
N₂O, N₂, CO₂, and compressed air;
N₂O, CO₂, Ar, and He;
N₂O, CO₂, Ar, and compressed air;
N₂O, Ar, He, and compressed air;
N₂, CO₂, Ar, and He;
N₂, CO₂, Ar, and compressed air;
N₂, Ar, He, and compressed air; or,
CO₂, Ar, He, and compressed air.

30. A pressurized container comprising:
a gas mixture comprising two or more gases selected from the group consisting of nitrous oxide (N₂O), nitrogen (N₂), carbon dioxide (CO₂), argon (Ar), helium (He), and compressed air; and
a liquid food product.

31. The pressurized container of claim 30, wherein when the gas mixture comprises two gases, a first gas is from about 5% to about 95% and a second gas is from about 5% to about 95% of the gas mixture:
wherein when the gas mixture comprises three gases, a first gas is from about 5% to about 90%, a second gas is from about 5% to about 90%, and a third gas is from about 5% to about 90% of the gas mixture: or
wherein when the gas mixture comprises four gases, a first gas is from about 5% to about 85%, a second gas is from about 5% to about 85%, a third gas is from about 5% to about 85%, and a fourth gas is from about 5% to about 85% of the gas mixture.

32-33. (canceled)

34. The pressurized container of claim 30, wherein the gas mixture comprises a blend of:
N₂O and N₂;
N₂O and CO₂;
N₂O and Ar;
N₂O and He;
N₂O and compressed air;
N₂ and CO₂;
N₂ and Ar;
N₂ and He;
N₂ and compressed air;
CO₂ and Ar;
CO₂ and He;
CO₂ and compressed air;
Ar and He;
Ar and compressed air; or,
He and compressed air.

35. The pressurized container of claim 30, wherein the gas mixture comprises a blend of:
N₂O, N₂, and CO₂;
N₂O, N₂, and Ar;
N₂O, N₂, and He;
N₂O, N₂, and compressed air;
N₂O, CO₂, and Ar;
N₂O, CO₂, and He;
N₂O, CO₂, and compressed air;
N₂O, Ar, and He;
N₂O, Ar, and compressed air;
N₂O, He, and compressed air;
N₂, CO₂, and Ar;
N₂, CO₂, and He;
N₂, CO₂, and compressed air;
N₂, Ar, and He;
N₂, Ar, and compressed air;
N₂, He, and compressed air;
CO₂, Ar, and He;
CO₂, Ar, and compressed air;
CO₂, He, and compressed air; or,
Ar, He, and compressed air.

36. The pressurized container of claim 30, wherein the gas mixture comprises a blend of:
N₂O, N₂, CO₂, and Ar;
N₂O, N₂, CO₂, and He;
N₂O, N₂, CO₂, and compressed air;
N₂O, CO₂, Ar, and He;
N₂O, CO₂, Ar, and compressed air;
N₂O, Ar, He, and compressed air;
N₂, CO₂, Ar, and He;
N₂, CO₂, Ar, and compressed air;
N₂, Ar, He, and compressed air; or,
CO₂, Ar, He, and compressed air.

37. The pressurized container of claim 30, wherein the container is a single chamber pressure-resistant container or a dual chamber pressure-resistant container comprising a base, a sidewall, and a valve, and wherein the container is pressurized to a total pressure of from about 0 psi to about the bursting pressure of the container.

38. (canceled)
